(19) United States
(12) Patent Application Publication
(10) Pub. No.: US 2014/0285015 A1
(43) Pub. Date: Sep. 25, 2014

(54) ELECTRIC CHARGE DRIVING SYSTEM

(71) Applicant: WHIRLPOOL S.A., Sao Paulo (BR)

(72) Inventors: Omar R. Murad, Rio Claro (BR); Ricardo Mota Lopes, Sao Paulo (BR)

(73) Assignee: WHIRLPOOL S.A., Sao Paulo (BR)

(21) Appl. No.: 14/221,924

(22) Filed: Mar. 21, 2014

(30) Foreign Application Priority Data
Mar. 22, 2013 (BR) 10 2013 006638 9

(51) Int. Cl. H02J 4/00

(52) U.S. Cl. CPC H02J 4/00
USPC 307/31

(57) ABSTRACT

The present invention relates to an electric system for driving electric charges, particularly meant to be applied in electric household appliances and, more preferably, for driving dispenser valves for the supply of water and inputs for washing. The system of the present invention is comprised of innovative technical and functional aspects responsible for simplifying the production lines of these appliances. More particularly, the charge driving system, according to the present invention, comprises a power driver (D) powered by a power source (V1), to carry a current flow to two electric charges (10, 20), each one connected to a corresponding one of filtering elements (D1, D2), which are installed in an inverted manner in relation to one another.

### FIELD OF THE INVENTION

The present invention relates to a charge driving electric system, which is made up of innovative technical and functional aspects capable to simplify the electric and electronic equipment production lines, particularly those electric household appliances of the washing machine type that comprise dispensers for supplying water and inputs for washing.

More particularly, the electric system for driving charges which is the object of the present invention comprises a construction capable of simplifying the electric household appliance production lines, mainly in view of the elimination and reduction of the number of components for controlling the driving of charges, such as solenoids and electromagnets responsible for driving electrovalves for the supply of water and inputs, for example.

### BACKGROUND OF THE INVENTION

According to the state of the art, it is well known that many electric-electronic equipments are driven by systems that require the arrangement and configuration of a series of components for enabling the selection, filtering and control of voltage and current, so as to allow for the proper driving of certain electric charges. More particularly in relation with the technological segment involving the household electric appliances in general and more especially in relation with those appliances that perform certain functions according to the driving of charges, such as the cleaning water and input feeding and draining valves in washing machines, as well as for the driving of other types of electric charge.

In this sense, it is known that today those appliances require the use of self-contained electric driving systems, so as to use selector keys capable of determining which electric charge is to be driven. More particularly, it is noted that the keying occurs to promote the powering of a particular electric branch and each one is comprised of a power driver, that is, each electric charge of the system requires its power driver capable of feeding it in an adequate manner.

Thus, as it should be appreciated by those skilled in the art, the electric household appliances commercially known end up in using an excessive amount of electric components for configuring their electric charge driving systems. This is because, as the number of charges to be driven increases in the equipment, the same number of power drivers will be necessary to promote the proper driving of all the equipment functionalities.

According to a practical example of that configuration known in the state of the art, one may mention the washing machines for clothes, which are provided with valves for feeding water and/or inputs for cleaning, such as soap, softening and bleaching agents, etc., those valves being driven in certain working cycles of the equipment, mainly in the more recent models, in which those valves are electronically drivers according to the washing cycle selected by the user.

Thus, as it should be clear to those skilled in the art, the need for depending on a power driver particularly designed for driving a respective charge ends up in increasing the costs for the manufacturers, both in relation with the acquisition of those components and in relation with their installation, making the manufacturing and assembly process more complex and, consequently, more expensive.

According to the state of the art some documents that disclose alternative systems for the driving of two charges, such as, for example, document U.S. Pat. No. 7,886,982, which discloses a multiple charge driving system using unified power drivers. However, as can be noted, this type of solution has the inconvenient of requiring a complementary key capable of promoting the electric circuit mechanic and/or manual keying according to the interest and intention of which charge is to be driven.

More particularly, it is noted that the purpose of the driving system disclosed in the prior art is to mechanically control two valves through a selecting key that connects one of the valves in a power driver of the TRIAC type and wherein the other valve is continuously driven, irrespective of said power driver. In other words, it is found out that this valve connected to the TRIAC is driven through the electric network entire cycle in a certain period of time.

Therefore, as is possible to find out, the state of the art lacks electric systems for driving two charges in an automated way and without the need for selector keys or any other mechanic means for effecting the choice of which charge is to be powered.

As should also be appreciated by those skilled in the art, it is noted that, in spite of the current equipments proving to be efficient and modern, the manufacturers constantly search for improving their products, and, often, these improvements are related to the optimization and simplification of the production lines, so as to obtain, apart from a modern product with advanced and innovating technology, a product at reduced costs. In other words, it is certain that one of the greatest challenges for the manufacturers is to succeed in developing and improving their products with new technologies, while maintaining or, preferably, reducing the manufacturing costs involved.

In that way, it is found out that the state of the art lacks electric charge driving systems capable of effectively optimizing the household electric appliances production lines in general, as well as providing a charge driving system presenting a straightforward configuration and, at the same time, effective in determining the driving of the respective electric charge desired.

### OBJECTS OF THE INVENTION

In view of the foregoing, it is one object of the present invention to provide an electric charge driving system, used particularly in appliances of the electric household type, the technical and functional characteristics of which are capable of improving and/or minimizing the drawbacks and limitations found in the state of the art known systems.

More particularly, it is one of the objects of the present invention to provide an electric charge driving system capable of substantially simplifying the household electric appliance production lines, especially in the cloth washing machine assembly lines.

Preferably, the purpose of the electric charge driving system according to the present invention is to drive and control two electric charges through a single power driver. More particularly, it is one object of this system to provide for the elimination of electric components in order to simplify and customize the household electric appliance manufacturing and assembly processes.

It is a further object of the present invention to provide an electric charge driving system which eliminates the need for selector keys that act mechanically on the electric household appliance electric circuit, but mainly, there is provided a driving system the characteristics of which allow for obtaining an effective control of the driving of charges according to the positive and negative electric network semi-cycles through a single power driver acting for both charges to be driven.

### SUMMARY OF THE INVENTION

Therefore, in order to achieve the objects and technical effects pointed out above, the present invention relates to an electric charge driving system that operates in a simplified way through a single power driver powered by a power supply, sad=id power driver responsible for controlling and selecting the current bias, so as to carry a current flow to two electric charges, each one connected to a corresponding filtering element, which are placed in a inverted manner in relation to one another, said filtering elements designed for blocking or releasing the passage of the current according to the equipment working cycle and the intention of driving the respective change.

According to a particularly advantageous embodiment of the present invention, said power driver of the electric charge driving system operates according to the electric network sinusoidal cutout technique, promoting the acquisition of signals generated by means of a control system with a microcontrolled base, which is further aided by complementary power conductors, of the “I/O Port” type for reading the electric network reference signal. Also, according to another embodiment of the present invention, said signal is a square wave where the positive semi-cycle represents logic level “1” and the negative semi-cycle represents logic level “zero”.

In addition, according to the present invention, said power driver of the electric charge driving system is a TRIAC or a solid state relay.

Also according to a preferably advantageous embodiment, said present invention driving system electric charges are of the solenoid type. More particularly, they are valves for feeding water and/or cleaning inputs used in cloth washing machines.

According to another alternative embodiment of the present invention, said filtering elements are diodes, which are capable of blocking and releasing the electric current flow according to the signal bias.

### BRIEF DESCRIPTION OF THE DRAWINGS

The characteristics, advantages and technical effects of the present invention, as pointed out above, will be better understood by those skilled in the art from the detailed description that follows, made merely by way of example, and not of limitation, of preferred embodiments, and by reference to the accompanying schematic figures, in which:

FIG. 1 shows the electric charge driving system electric circuit, object of the present invention; and

FIG. 2 schematically shows the process of identifying the point of determination of the change of the electric network cycles essential to the driving system object of the present invention.

### DETAILED DESCRIPTION OF THE INVENTION

According to the schematic figures mentioned above, there will be described in more detail some examples of possible embodiments of the present invention, being understood that they relate to a merely illustrative, and not llmitating, description, since the present electric charge driving system may be constructed and configured with different technical, structural and dimensional characteristics, without departing from the desired protection scope.

In addition, as should be appreciated by those skilled in the art, though the present description mentions as a means of applying the electric charge driving system a cloth washing machine, it becomes apparent that this definition aims, solely and exclusively, at promoting a merely illustrative form of helping to interpret and circumscribe the present invention protection scope. This because it is clear that the present driving system may be easily applied in different equipments that operate and require the control over the proper driving of electric charges, such as, for example, equipments of the cloth washing machine, cloth drying machine and water purifier type.

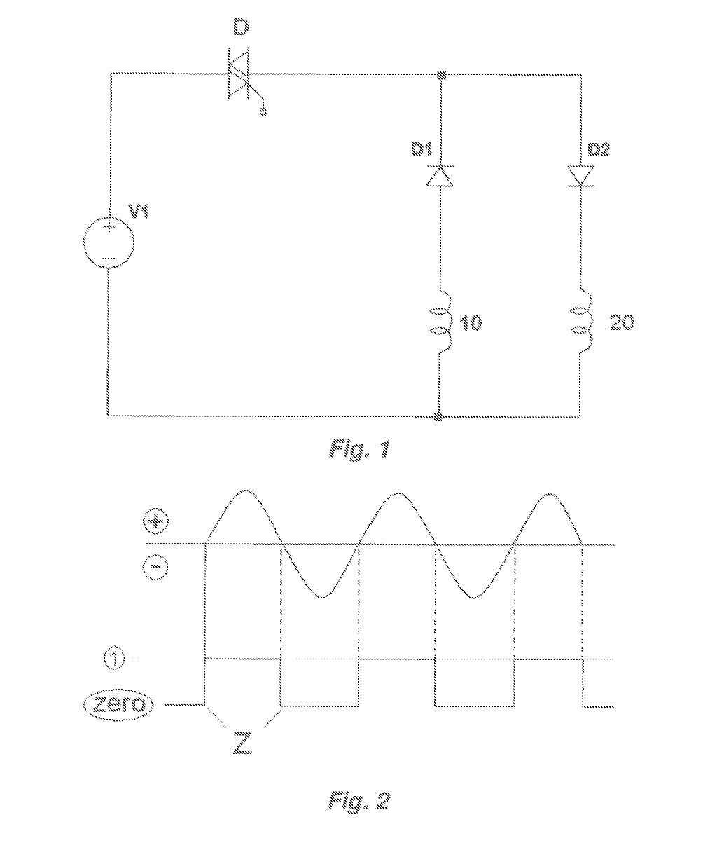

According to FIG. 1, it can be seem that the electric charge driving system is comprised of e power driver D fed by a power source V1 responsible for feeding power to the respective electric charges 10 and 20, each one being arranged after a respective filtering element D1 and D2, said filtering elements D1 and D2 being installed in an inverted manner in relation to one another.

More particularly, and as shown in FIG. 1, the electric charge driving system according to the present invention succeeds, through a single power driver D, in controlling the level of electric current to be conducted towards said charges 10 and 20, but mainly in establishing which semi-cycle is to be used by the system, be it positive or negative, according to the electric network sinusoidal wave supplied by power source V1. It is noted that said power driver D operates using the electric network sinusoidal cutout technique and, thereby, it becomes possible to determine the type and bias o the signal feeding charges 10 and 20. According to a preferably advantageous embodiment of the present invention, said power driver D may be one among a TRIAC, a solid state relay and a power key.

Additionally, according to another advantageous variant of the present invention, said electric charges 10 and 20 are of the solenoid type, since such components do not have any preferential magnetization direction and, therefore, irrespective of the current bias, both positive and negative, this type of component operates normally.

As a complementation, said filtering elements D1 and D2 are preferably diodes configured to withstand the currents generated by source V1 and conducted by said power driver D. As previously mentioned, these diodes are arranged in an inverted manner in relation to one another, since their purpose is to allow the passage of only the current with the suitable bias. In other words, if said power driver D drives the system with a current having a positive bias, that is, in the positive semi-cycle, charge 20 will be driven once filtering element D2 is positioned in the anode-cathode direction, and the other charge 10 will not receive any signal and will remain deactivated, since said filtering element D1 is positioned in the opposite direction.

In compensation, when power driver D inverts the current bias, allowing only the passage of negative current flow, filtering element D blocks the passage of the electric current and deactivates charge 20 and, at the same moment, filtering element D1 allows the passage of the current in the negative direction and, consequently, charge 10 will be driven.

According to a possibility of the present invention and, for example, in a situation in which one wishes to drive the two charges 10 and 20 together, it is possible to adjust said power driver D in its 100% mode, promoting the passage of the current flow in the two semi-cycles, both positive and negative, so that the two charges can be driven simultaneously, each one in view of the corresponding current which is not filtered by the respective filtering element D1 and D2.

Thus, as should be noted by those skilled in the art, the electric charge driving system, object of the present invention, comprises three operating modes, which are: the isolated driving of charge 10 only, the isolated driving o charge 20 only, or the simultaneous driving of charges 10 and 20.

According to a preferably advantageous solution of the present invention, the electric charge driving system is meant to be applied in a household electric appliance, such as, for example, a cloth washing machine, said charges 10 and 20 are valves feeding water and/or cleaning inputs which must be driven in certain moments of the washing cycle selected by the user.

In brief, it is noted that the operation of the electric charge driving system, according to the present invention, consists in using a power driver capable of selecting and determining the current flow direction combined with the arrangement of filtering elements positioned in strategic locations relative to the respective charges, in order to block or release the currant flow, according to the bias, allowing for the driving and switching off of the respective charges.

Therefore, as should be clear to those skilled in the art, the electric charge driving system, according to the present invention, does not require the use of selector keys which need the user's manual driving. In addition, it succeeds in optimizing the equipment manufacturing and assembly process, since the need for providing a particular power driver for each charge one wishes to drive is eliminated.

FIG. 2 schematically shows the process of identifying and determining the point for changing the electric network cycles according to the system of the present invention. More particularly, said cycle point of change is referred to in the art as “zero cross” Z, which refers to the moment in the sinusoidal wave in which the electric current flow AC is changed, that is, the point in which the sinusoidal wave goes from the positive to the negative, and vice-versa.

According to a advantageous embodiment of the present invention, the driving of power driver D is effected by means of a control system with a microcontrolled base an with the aid of other power conductors, so that, through a “I/O Port” type of port, an electric network reference signal V1 is read, said signal being a square wave where the positive semi-cycle represents logic level “1” and the negative semi-cycle represents logic level “zero”. Thus, based on the square wave generated, it is possible to detect the so called “zero-cross”, that is, the detection is performed based on the transition between the logic levels and, consequently, one knows the moment and that the signal has changed pole.

At last, it is important to stress that the purpose of the above description is only to describe in an illustrative manner some preferred embodiments of the electric charge driving system according to the present invention. So, as those skilled in the art will understand, numerous modifications, variations and constructive combinations of the elements that perform the same function substantially the same way are possible to achieve the same results, which are within the protection scope, as circumscribed by the appended claims.

1. An electric charge driving system, CHARACTERIZED in comprising a power driver (D) powered by a power source (V1) to carry a current flow to two electric charges (10, 20), each one connected to a corresponding filtering element (D1, D2), which are installed in an invented manner in relation to one another.

2. An electric charge driving system, according to claim 1, CHARACTERIZED in that said power driver (D) operates according to the electric network (V1) sinusoidal cutout technique.

3. An electric charge driving system, according to claim 1, CHARACTERIZED in that said power driver (D) may be one among a TRIAC, a solid state relay and a power key.

4. An electric charge driving system, according to claim 1, CHARACTERIZED in that said electric changes (10, 20) are of the solenoid type.

5. An electric charge driving system, according to claim 1, CHARACTERIZED in that said filtering elements (D1, D2) are diodes.

6. An electric charge driving system, according to claim 1, CHARACTERIZED in that it is applied in electric household appliance, such as a cloth washing machine, said charges (10, 20) being valves for feeding water and/or cleaning inputs.

7. An electric charge driving system, according to claim 1, CHARACTERIZED in that the driving of the power driver (D) is effected by means of a control system with a microcontrolled base.

8. An electric charge driving system, according to claim 7, CHARACTERIZED in that it further comprises auxiliary power conductors, of the “I/O Port” type, for reading the electric network (V1) reference signal.

9. An electric charge driving system, according to claim 8, CHARACTERIZED in that said signal is a square wave where the positive semi-cycle represents logic level “1” and the negative semi-cycle represents logic level “zero”.
